(19) United States
(12) Patent Application Publication
(10) Pub. No.: US 2009/0108797 A1
(43) Pub. Date: Apr. 30, 2009

(54) METHOD FOR DRIVING AN ASYNCHRONOUS MOTOR AND PUMP ARRANGEMENT WITH ASYNCHRONOUS MOTOR

(76) Inventor: Sebastian Haas, (US)

Correspondence Address: HAYES SOLOWAY P.C., 3450 E. SUNRISE DRIVE, SUITE 140, TUCSON, AZ, 85718, US

(21) Appl. No.: 12/237,318

(22) Filed: Sep. 24, 2008

(30) Foreign Application Priority Data
Oct. 25, 2007 (EP) 07 119 311.4

(51) Int. Cl. H02P 27/04

(52) U.S. Cl. 318/801

(57) ABSTRACT

A method for driving an asynchronous motor operated at an adjustable three-phase frequency to a predetermined target rotational speed is disclosed. For controlling the asynchronous motor in an operating range around its breakdown point a current rotational speed of the asynchronous motor is determined at predetermined intervals and the three-phase frequency is adjusted stepwise such that the current rotational speed lies within a predetermined maximum rotational speed deviation of an updated three-phase frequency.

### BACKGROUND OF THE INVENTION

The present invention relates to a method of driving an asynchronous motor as is used in pumps, for example. The invention further relates to an arrangement with one or more pumps for providing pressurized cryogenic fluid, this arrangement being suitable for use in an air liquefaction unit, for example.

The driving and control of electric motors, and asynchronous motors in particular, which are driven with three-phase alternating current is necessary in various fields of use. Corresponding electric motors may be used, for example, for driving pumps. Frequently cryogenic pumps are used, in other words pumps which deliver cryogenic fluids at temperatures of less than −170° C. with corresponding three-phase asynchronous motors. Particularly in the case of low-temperature applications, such as for example air separation units, a cryogenic fluid such as liquefied air is brought by cryogenic pumps to a predetermined operating pressure and is then passed on to other parts of the system, such as a heat exchanger.

In order to maintain as reliable and even a pressure in the cryogenic fluid as possible, redundant pumps are mostly operated in parallel in order to maintain the necessary pressure in the low-temperature system if one of the pumps fails. For example, redundant pairs of pumps may be provided wherein a working pump is constantly in use and in the event of its failure a substitute pump is started, substituting the performance of the failed pump. It is known to have what are referred to as “slow-roll” operating modes for such substitute pumps where, although the drive motor is active, the pump still practically does not perform any delivery work.

In order to prevent too great a fall in pressure in the high-pressure region of the corresponding system if the working pump fails, it is necessary to bring the redundant substitute pump as quickly as possible into the operating state corresponding to the original operating state of the working pump. This means that generally the rotational speed of the substitute pump must reach the rotational speed of the failed working pump as quickly as possible. Normally the rotational speed of the particular activated pump is determined by the relevant system's operating parameters and is adjusted in a closed-loop circuit. The rotational speed of an asynchronous motor is substantially predetermined by the three-phase frequency at which it is operated. Therefore in the case of conventional control a frequency converter is used which provides the three-phase frequency for the motor driving the pump. A corresponding control device determines the three-phase frequency for the pump and asynchronous motors as a function of the pressure of the product present on the output side of the pump.

If a pump fails, this set frequency value is also used for the substitute pump. In the case of corresponding conventional control it is a disadvantage that the newly starting substitute pump only develops a weak torque and therefore the ramp-up function for the substitute pump is delayed, causing fluctuations in pressure and volume of the delivered product.

It is therefore an object of the present invention to provide an improved method of ramping up pumps or asynchronous motors.

### SUMMARY OF THE INVENTION

Accordingly a method of driving an asynchronous motor operated by an adjustable three-phase frequency to a predetermined target rotational speed is provided. In doing so a current rotational speed of the asynchronous motor is determined at predetermined intervals for controlling the asynchronous motor in an operating range around its breakdown point. The three-phase frequency is further adapted stepwise such that the current rotational speed lies within a predetermined maximum rotational speed deviation from an updated three-phase frequency.

The breakdown point of an asynchronous motor corresponds on a torque-speed curve of the motor to the so-called “breakdown speed”, which corresponds to a maximum rotational speed of the motor. In the proposed method, the fact is exploited that the motor torque is greatest in the proximity to the breakdown point and thus greater angular acceleration results during ramp-up. In this manner the ramp-up time until reaching the desired rotational speed is reduced. By means of a predetermined maximum rotational speed deviation it is guaranteed that during the ramp-up function, in other words by the time the target rotational speed is reached, the asynchronous motor has an operating point which at most then varies by the maximum rotational speed deviation around its breakdown torque or its breakdown speed. The method is suitable particularly in operating situations wherein a higher-level control prescribes a jump in the synchronous speed or three-phase frequency which would carry away the operating point of the motor on its speed-torque curve from the respective breakdown torque. This can be the case, for example, when ramping up the asynchronous motor but also when an increase in rotational speed is required within a short time because of other circumstances.

In the method one or more of the following method steps can be performed:

Setting a maximum rotational speed deviation such that for all synchronous speeds said deviation equals the difference between a synchronous speed and the breakdown speed corresponding to that synchronous speed according to a torque-speed curve of the asynchronous motor. By this means a step length is predetermined for the increase in the three-phase frequency when ramping up the asynchronous motor to the target rotational speed. Since the maximum rotational speed deviation is chosen such that the breakdown speed is within the interval between the synchronous speed, in other words the currently set three-phase frequency, minus the maximum rotational speed deviation, advantageously an operating point in the proximity to the breakdown point of the asynchronous motor is always obtained.

Setting a target rotational speed. The target rotational speed may, for example, match the speed at which a failed asynchronous motor or a failed pump was operated.

Operating the asynchronous motor at a three-phase frequency which matches the target rotational speed. In the case of conventional closed-loop circuits the rotational speed is mostly adjusted as a function of the fluid pressure resulting on the output side of the particular pump arrangement.

Determining the current rotational speed of the asynchronous motor. The current rotational speed of the asynchronous motor results from the three-phase frequency at which the asynchronous motor is currently operated and the flow conditions, in other words indirectly from the resulting hydraulic torques in the pump and/or pipe system. The hydraulic torque results from the volumetric flow, the differential pressure between the pump's input and output sides and the current rotational speed. The current rotational speed may, for example, be measured directly on a shaft of the pump or motor or by indirect means.

Updating the three-phase frequency to an updated three-phase frequency which corresponds to the current rotational speed increased by the maximum rotational speed deviation, if the current rotational speed is lower than the target rotational speed and, in particular, is less than the target rotational speed minus the maximum rotational speed deviation. Accordingly, there may be a successive increase in the three-phase frequency such that the asynchronous motor is operated in the proximity of its breakdown point and therefore develops a high torque. By this means a particularly high angular acceleration results during the ramp-up phase, by which means the target rotational speed overall is rapidly achieved.

According to one aspect the maximum rotational speed deviation for all rotational speeds is less than the difference between the breakdown speed and the synchronous speed of the asynchronous motor. For example, it is possible to assume that by varying the synchronous speed the torque-speed curve of the present asynchronous motor is only displaced on the X-axis, in other words with the rotational speed. The requirements for the maximum rotational speed deviation are then satisfied for all synchronous speeds and three-phase frequencies.

In one variant of the method the current rotational speed of the asynchronous motor is determined as a function of a power consumption of the asynchronous motor. Whilst in many closed-loop circuits the power consumption of individual parts of the system can be picked off, for example in the case of an asynchronous motor, the measurement or determination of the rotational speed of a shaft can sometimes be performed only with considerable effort. Generally, however, the current rotational speed can be estimated with the help of a rotational speed-power consumption curve of the asynchronous motor. Consequently, no direct measurement of the rotational speed is necessary, which thus facilitates the implementation of the method.

For example, the three-phase frequency can then be adjusted by controlling the power consumption of the asynchronous motor. In the process, the previously explained maximum rotational speed deviation corresponds to a maximum power consumption deviation. In principle it is also possible to map the speed-torque curve on a speed-power consumption curve, so that with the corresponding control of power consumption the corresponding maximum power consumption deviation is used with the maximum rotational speed deviation. Generally power consumption increases with the deviation from the synchronous speed, in other words a characteristic power consumption can be determined at the breakdown point of the asynchronous motor. At synchronous speed the motor consumes a minimum to negligible amount of current. The control of the current is therefore performed such that the power consumption is within a predeterminable range corresponding to a maximum desired power consumption. If the power consumption is higher the motor functions well to the left of its breakdown point in the corresponding speed-torque curve. Then the three-phase frequency is adjusted in the direction of the power consumption to correspond to the breakdown point. By this means it is guaranteed that the asynchronous motor is operated in the proximity of its breakdown point.

The invention further relates to a pump arrangement with at least one working pump, at least one substitute pump which has an asynchronous motor and a frequency converter for providing a three-phase alternating current and a control device which performs an above-described method for controlling the asynchronous motor of the substitute pump to a target rotational speed.

As already mentioned previously, asynchronous motors are especially suitable for operating centrifugal pumps which deliver or compress cryogenic fluids. In one application the target rotational speed corresponds, for example, to a current rotational speed of the working pump or to the rotational speed prior to failure of a working pump. The control device can thus be designed such that on failure of a working pump the substitute pump is activated and is brought up to the rotational speed of the failed working pump.

According to another aspect an apparatus is provided for providing pressurized cryogenic fluids which has a corresponding pump arrangement. In said further development cryogenic pumps as working or substitute pumps apply a predetermined pressure to cryogenic fluid provided from a reservoir. The control device further controls a rotational speed of the working pump as a function of the predetermined pressure.

This is, for example, an application in low-temperature air separation units in which one or more heat exchanger devices are delivered liquefied air at the predetermined pressure as cryogenic fluid.

Further a computer software product is provided which instigates the performance of a corresponding method for driving an asynchronous motor on a program-controlled computer or control device. A PC or a computer at a control center can be viewed as a program-controlled computer or control device for the open and closed-loop control of systems on which PC or computer corresponding software is installed. The computer software product may, for example, be implemented in the form of a data carrier such as a USB stick, floppy disk, CD-ROM, DVD, for example, or else as a downloadable program file on a server device.

Further advantageous developments of the invention feature in the sub-claims and embodiments of the invention described below. Moreover the invention is explained in more detail by reference to preferred developments referring to the attached figures.

### BRIEF DESCRIPTION OF THE DRAWINGS

FIG. 1: a representation of a system with a plurality of controllable pumps for providing a pressurized cryogenic fluid;

FIG. 2: a schematic representation of an embodiment of a pump;

FIG. 3: a torque-speed curve of an asynchronous motor;

FIG. 4: a plurality of torque-speed curves of asynchronous motors for demonstrating a variant of the method for driving an asynchronous motor;

FIG. 5: a representation of controlled steps according to a variant of the method for a system according to FIG. 1; and

FIG. 6: a power consumption-speed curve of an asynchronous motor.

### DETAILED DESCRIPTION OF EMBODIMENTS

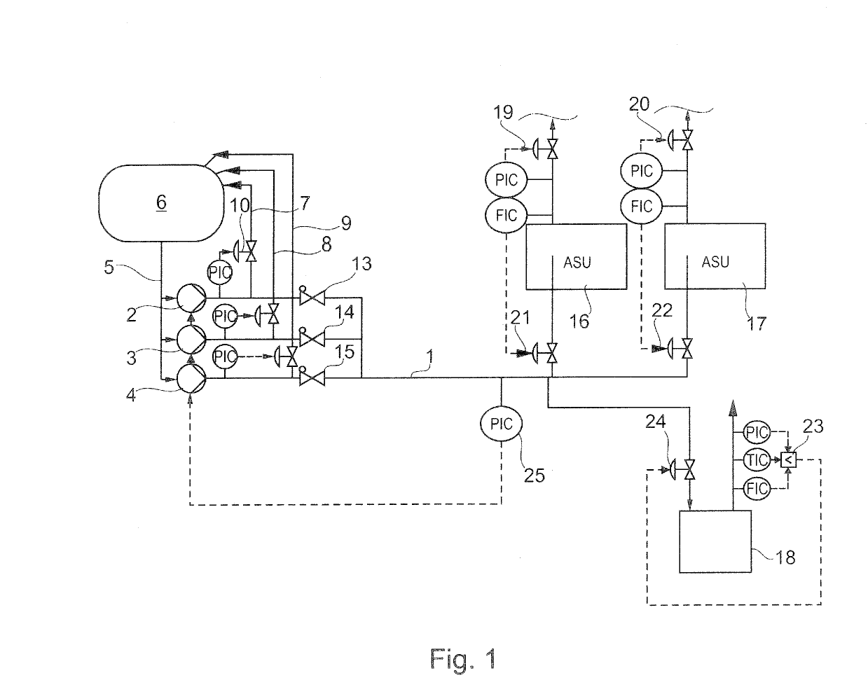

In the case of air separation units with internal compression, cryogenic air or fluids (LIN, LOX, LAR=liquid nitrogen, oxygen, argon), for example, are brought to an operating pressure by means of pumping or compression and are delivered to a heat exchanger of the corresponding air separation unit (ASU). The corresponding cryogenic fluid is then evaporated therein. In order to allow the particular process to be continued despite the failure of one of the pumps, redundant pumps are provided which on failure of the actual working pump start operating as a substitute pump. It is also conceivable that several individual system parts are provided with pressurized cryogenic fluid from a common reservoir or tank. This is schematically shown in FIG. 1, for example.

A common high-pressure fluid line 1 is provided which is supplied with high-pressure fluid by three pumps 2, 3, 4. The pumps draw the particular product via a feed line 5 from a common reservoir or tank 6. For each pump a bypass return 7, 8, 9 is provided with one pressure-controlled valve 10, 11, 12 each. Each pump 2, 3, 4 is further safeguarded by means of a non-return valve 13, 14, 15 against the common high-pressure fluid line.

In the example in FIG. 1, three system parts are connected to the common high-pressure fluid line 1. For example, two heat exchangers 16, 17 of ASUs and a back-up system 18 are coupled to the common high-pressure fluid line 1. On the gas side, the respective product pressure is controlled via pressure-controlled valves 19, 20. The respective necessary product volume is also controlled via valves 21, 22. Similarly the removal of high-pressure fluid from the common line 1 takes place by means of the back-up system 18 via a valve 24 which is controlled by a controller 23.

Via a control device 25 the necessary pressure is controlled by driving the pumps 2, 3, 4 in the common high-pressure line 1. In normal operation, the pump bypasses 7, 8, 9 are closed, and a suitable three-phase frequency is predetermined for the pumps and the asynchronous motors installed therein. Generally, the number of pumps 2, 3, 4 provided matches the number of sub-systems drawing from the common high-pressure line 1.

If a pump fails, a redundant substitute pump must be ramped up as quickly as possible in order to minimize pressure fluctuations in the common fluid line 1. In normal operation, the controller or the control device 25 transmits a predetermined three-phase frequency nsyn to the pumps.

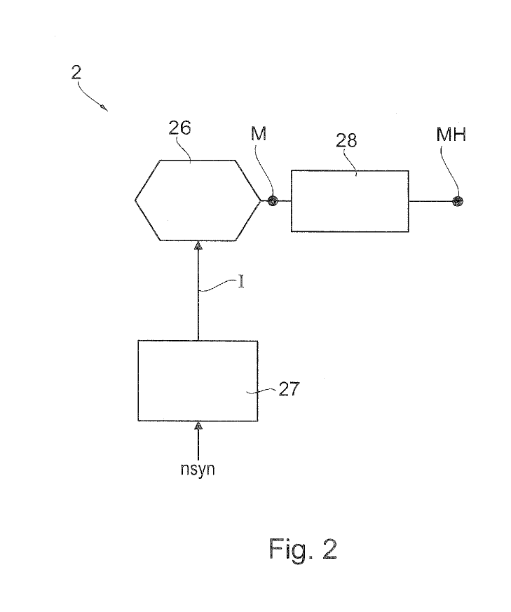

FIG. 2 shows schematically a possible pump construction. An asynchronous motor 26 delivers a motor torque M as a function of a supplied three-phase alternating current I with a predetermined three-phase frequency, said motor torque M generating a hydraulic moment MH via impellers 28 of a corresponding centrifugal pump 2. The three-phase frequency and three-phase alternating current I may be supplied by a controllable frequency converter 27 to which the pressure regulator 25 communicates the necessary three-phase frequency nsyn.

In FIG. 1 the symbols for the compressor or pumps 2, 3, 4 each correspond to an arrangement with frequency converter, asynchronous motor and pump impellers. So-called “centrifugal” pumps are frequently used. The pressure regulator 25 then defines the particular three-phase frequency. The rotating members or impellers 28 have a moment of inertia Θ. The equation of motion for a rotating mass from the angular momentum results as:

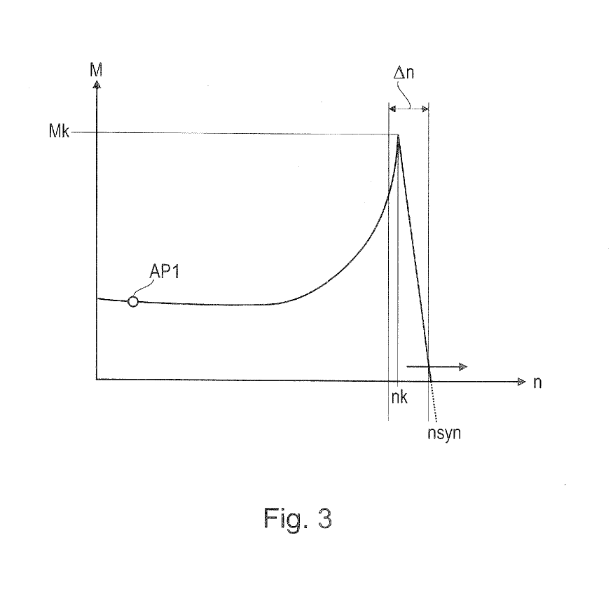

In FIG. 3, a motor curve is shown as the torque M as a function of the motor speed n. The curve provided in FIG. 3 by way of example corresponds to an asynchronous motor. Asynchronous motors are also referred to as three-phase asynchronous motors, asynchronous motors or squirrel-cage motors. The rotational speed n corresponds to the rotational frequency in units of revolutions per unit of time, such as for example revolutions or changes of polarity per second or per minute. The torque-speed curve describes how the motor reacts to a torque or load torque required from its shaft. If the required moment is less than the torque M of the motor, the motor accelerates and the rotational speed n increases. Rising parts of curves are unstable and falling parts of curves are stable.

The torque M of an asynchronous motor has a maximum MK at the breakdown frequency nk. If the motor inductor, i.e. the rotor, rotates at the same speed as the magnetic field generated by the three-phase alternating current, the motor does not provide torque. This is the case with the synchronous speed nsyn. A particularly high torque and thus, in accordance with the angular momentum, a high acceleration of the angular velocity ω of the motor axis, arises an the proximity of the breakdown point MK, nk.

According to the arrangement in FIG. 1 the same three-phase frequency is connected into all the pumps and asynchronous motors 2, 3, 4. In other words, when a pump is activated and has to be brought up to a target rotational speed, wherein the target rotational speed generally corresponds to the rotational speed of the pumps that are operating or to the latest rotational speed of the failed pump, the substitute pump will begin in an operating point AP1 which only has a low motor torque M. Ramping up and reaching the target rotational speed can thus only be achieved slowly. In FIG. 3, furthermore, a maximum rotational speed deviation Δn is stated which is chosen such that the breakdown point MK, nk is within a rotational speed range which lies between nsyn—Δn and n.

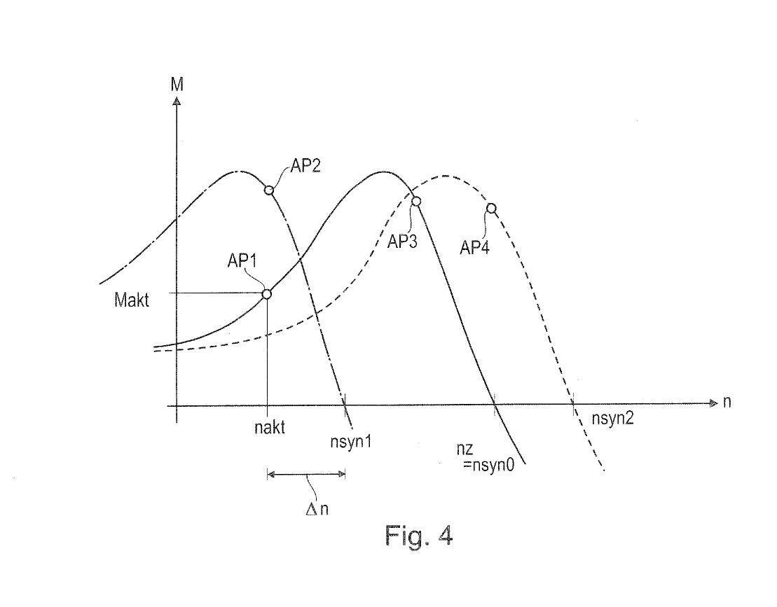

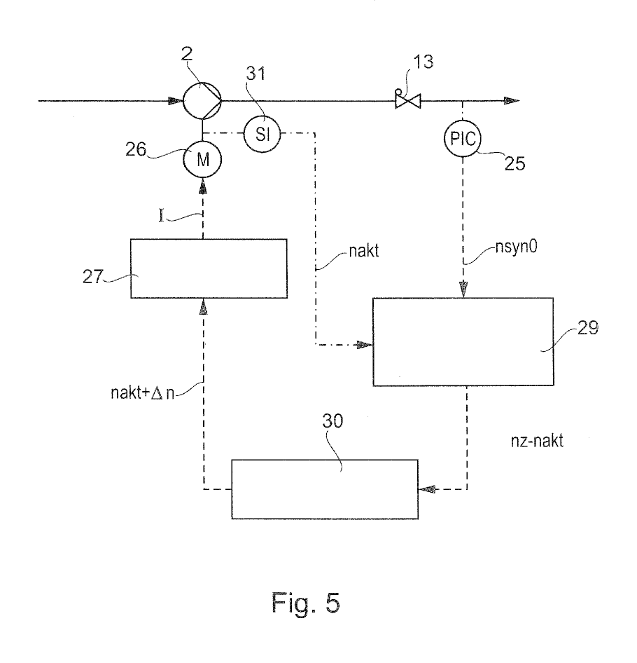

According to the below-described variant of the method for driving an asynchronous motor according to the invention, a particularly high acceleration of the impeller is achieved thereby and the highest possible a torque is guaranteed by the motor. This is explained in more detail in FIGS. 4 and 5. It is necessary, for example, to ramp up a substitute pump, for example pump 2, because pump 3 or 4 has failed in a system as described in FIG. 1. For example, in normal operation the necessary pressure can be guaranteed by two working pumps 3, 4. Because of the failure of a pump, to maintain the required pressure in line 1 the controller 25 supplies a rotational speed or frequency for the three-phase alternating current which is higher than the latest value for the three-phase frequency of the failed pump 3. In the case of conventional closed-loop control, the substitute pump 2 would receive this higher rotational frequency value from the pressure regulator 25. However, during ramp-up the substitute pump 2 to be newly switched on is in a different operating state. The goal is to bring the substitute pump 2 as quickly as possible to the target rotational speed nz=nsyn0, which can match the last rotational speed of the failed pump 3. However, it is also possible that because of the system's operation the pressure regulator 25 proposes a different target rotational speed at its outlet up to which the substitute pump is to be brought as quickly as possible.

In a first step the target rotational speed nz=nsyn0 is thus connected into the substitute pump 2 as a three-phase frequency. The resultant torque-speed curve is shown as a continuous curve in FIG. 4. At the same time the current rotational speed nakt of the substitute pump 4 is determined. In particular at the start of the ramp-up function this rotational speed will lie within an obviously lower range than the target rotational speed nz. In FIG. 4, for example, a current rotational speed nakt is stated. Looking at the torque-speed curve of the particular motor of the pump 2, a torque Makt results which is obviously lower than the associated breakdown torque Mk. The current rotational speed nakt of the substitute pump 2 can take place through conventional measurements, for example, optically, inductively or capacitatively.

Being aware of the current rotational speed nakt, the three-phase frequency may be updated in a subsequent step. This preferably takes place such that the currently measured rotational speed comes within an operating range including the breakdown point corresponding to the particular synchronous speed nsyn1. Now, for example, an updated three-phase frequency is used which deviates by a maximum of Δn, in other words by the maximum rotational speed deviation from nakt. An updated three-phase frequency is thus set which corresponds to an updated synchronous speed nsyn1. The corresponding curve is shown by a dot-dash line in FIG. 4.

Through the displacement of the curve to the new updated three-phase frequency nsyn1, a far more favorable operating point AP2 results for the asynchronous motor. This means that an considerably higher torque moment is achieved, and the rotational frequency or rotational speed is accelerated according to the angular momentum.

After a predetermined time step the synchronous speed can be updated once again. The respective operating point is preferably always slightly to the right of the breakdown point. There thus results a stepwise increase in the three-phase frequency at which the substitute motor or substitute pump is operated. If the updating is undertaken stepwise in steps of Δn, the substitute pump or substitute synchronous motor and achieves in the most rapid manner the operating point AP3 shown in FIG. 4 as a continuous curve. This may correspond, for example, to the operating point and synchronous speed at which the failed working pump operated. It is therefore guaranteed that when ramping up the substitute pump it is practically always operated in the proximity of its breakdown point and therefore achieves the target rotational speed nz particularly rapidly. In order to achieve the target rotational speed nz with the best possible torque, a synchronous speed nsyn2 or a three-phase frequency can be set which is shown by the broken curve, so providing an operating point AP4 of the pump which develops a torque to the right of the breakdown point in the case of the target rotational speed nz. Preferably the rotational speed corresponding to the operating point AP4 is displaced at most by a maximum rotational speed deviation Δn from the breakdown speed in the direction of the synchronous speed.

FIG. 5 shows a representation of the control operations in a cut-out of the system shown in FIG. 1, which concerns the substitute pump 2, the pump drive or asynchronous motor 26, the non-return valve 13 and the pressure regulator 25. A frequency converter 27 provides three-phase alternating current I to the asynchronous motor 26. As described previously, at predetermined points in time, for example operated at a clock frequency as predetermined by a control center computer, an interrogation 29 of the current rotational speed nakt of the asynchronous motor 26 takes place. The current rotational speed nakt can, for example, be provided by an optional speed or revolution counter 31. It is also possible, as explained below, to derive the rotational speed nakt from the power consumption.

Through a suitable comparison device 29, for example implemented in the manner of a routine of a sequential program for a control center computer, it is determined whether the controller output of the pressure regulator 25 proposes a higher rotational speed nsyn0 than the current rotational speed nakt. In an interrogation device 30, which may also be implemented by means of a computer, it is calculated whether the difference between the actual current rotational speed nakt and the rotational speed nsyn0 predetermined by the controller 25 is greater than the maximum rotational speed deviation Δn described above. If this is the case, the current three-phase frequency nakt+Δn increased by one step Δn is transferred to the frequency converter 27. Otherwise the rotational speed value provided by the pressure regulator 25 is applied.

In a system which provides pressurized cryogenic fluid, such as for example liquefied air in a common pipe train for several system parts, it is therefore guaranteed that even if a working pump fails the necessary pressure and volume of cryogenic compressed fluid is available. Fluctuations in pressure and product volume when pumps fail are thus considerably reduced.

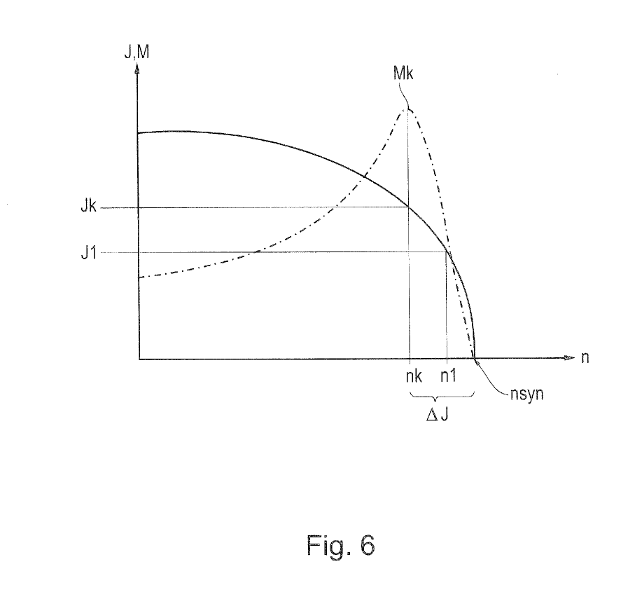

As an alternative to directly determining the current rotational speed of the substitute pump for ramping up, it is also possible to indirectly determine it as a function of the volume of current consumed by the pump. In FIG. 6 a power consumption-speed diagram for an asynchronous motor is shown by way of example. The power consumption J is shown as a function of the rotational speed n. In the same diagram the corresponding torque-speed curve is shown by dot-dash lines. If the pump runs at the synchronous speed nsyn, practically no current is used, which is represented by the arrow in FIG. 6. Corresponding current-speed curves are known generally. Therefore a maximum power consumption Jk can be determined which corresponds to the power consumption in the breakdown point Mk at the breakdown speed nk. If, for example, a power consumption J1 is measured, a rotational speed n1 results therefrom with the corresponding synchronous speed nsyn. By limiting power consumption to a maximum value Jmax≈Jk, it is also possible for the operating point of the asynchronous motor not to be operated to the left of its break-down point in the corresponding torque-speed curve with maximum torque therefore being displayed.

To this extent, the easily accessible measurement of the power consumption J of the individual pumps is one possibility for measuring rotational speed. Since often a measurement of the rotational speed is not provided for as standard in the case of cryogenic pumps, further costs can be saved through indirect determination of rotational speed via power consumption.

In addition, by mapping power consumption to the rotational speed or vice versa a maximum power consumption deviation ΔJ can be defined which corresponds to the maximum rotational speed deviation Δn. In the case of a depiction of the power consumption-speed curves on a torque-speed curve diagram a further possibility is thus provided to always operate the pump in the proximity to its breakdown point when ramping it up stepwise in the form of steps in power consumption. This will be of special advantage if on the system control side the rotational speeds of the pumps used are controlled through their power consumption.

One advantage of the proposed driving of asynchronous motors, in particular as drives for cryogenic pumps, also lies in the fact that higher-level control of rotational speed, as provided for by the pressure regulator 25 in FIG. 1, for example, is unaffected. In the event that there is too great a deviation of the current rotational speed from the synchronous speed which the pressure regulator 25 predetermines, its initial value, which is transferred to the respective frequency converter 27 (FIG. 2) is overwritten, so that a successive adjustment of the three-phase frequency until achievement of the necessary rotational speed predetermined by the pressure regulator 25 is achieved.

Although the present invention has been described by reference to preferred practical examples, particularly in relation to cryogenic pumps, it is not restricted to these but can be modified in diverse ways. The operation of an asynchronous motor by stepwise raising the three-phase frequency can also be applied in other fields of application in which asynchronous motors are started. Further, the method is not restricted to use in pump arrangements employed in air separation units or gas liquefaction units. In particular, the proposed method steps can be implemented within a closed-loop control or on a control center computer of the corresponding (industrial) system.

1. A method for driving an asynchronous motor comprising to a predetermined target rotational speed:
operating an asynchronous motor with an adjustable three-phase frequency;
determining a current rotational speed of said asynchronous motor at predetermined time intervals for controlling said asynchronous motor to an operating range around its breakdown point; and
adjusting said three-phase frequency stepwise such that said current rotational speed lies within a predetermined maximum rotational speed deviation of an updated three-phase frequency.

2. The method according to claim 1, further comprising:
determining a maximum rotational speed deviation such that for all synchronous speeds the maximum rotational speed deviation includes a difference between a synchronous speed and that of the breakdown speed corresponding to the synchronous speed according to a torque-speed curve of said asynchronous motor;
determining a target rotational speed;
operating the asynchronous motor at a three-phase frequency corresponding to the target rotational speed;
determining the current rotational speed of the asynchronous motor; and
updating the three-phase frequency to an updated threephase frequency which corresponds to the current rotational speed increased by the maximum rotational speed deviation, if the current rotational speed is lower than the target rotational speed reduced by the maximum rotational speed deviation.

3. The method according to claim 1, wherein the maximum rotational speed deviation for all rotational speeds is lower than the difference between the breakdown speed and the synchronous speed of the asynchronous motor.

4. The method according to claim 1, wherein the current rotational speed of the asynchronous motor is determined as a function of a power consumption of the asynchronous motor.

5. The method according to claim 1, wherein adjusting said three-phase frequency comprises:
controlling the power consumption of the asynchronous motor, wherein the maximum rotational speed deviation corresponds to a maximum power consumption deviation.

6. A pump arrangement comprising:
at least one working pump,
at least one substitute pump having an asynchronous motor operated with an adjustable three-phase frequency and a frequency converter for providing three-phase alternating current, and
a control device which is implemented to drive said asynchronous motor of said at least one substitute pump to a predetermined target rotational speed, wherein for controlling the asynchronous motor to an operating range around its breakdown point a current rotational speed of the asynchronous motor is determined at predetermined time intervals and the three-phase frequency is adjusted stepwise such that the current rotational speed lies within a predetermined maximum rotational speed deviation of an updated three-phase frequency.

7. The pump arrangement according to claim 6, wherein said predetermined target rotational speed corresponds to a current three-phase frequency of a working pump operated with an asynchronous motor.

8. The pump arrangement according to claim 6, wherein said control device is designed such that in the case of failure of said at least one working pump, said substitute pump is activated and is brought to the rotational speed of the failed working pump.

9. An apparatus for providing pressurized cryogenic fluid comprising a pump arrangement according to claim 6, wherein a plurality of cryogenic pumps as working or substitute pumps apply a predetermined pressure to cryogenic fluid provided from a reservoir and wherein said control device further controls a rotational speed of the working pump as a function of said predetermined pressure.

10. An apparatus for low-temperature air separation comprising an apparatus according to claim 9 and at least one heat exchanger device to which liquefied air at the predetermined pressure is applied as a cryogenic fluid.

11. The method according to claim 2, wherein the maximum rotational speed deviation for all rotational speeds is lower than the difference between the breakdown speed and the synchronous speed of the asynchronous motor.

12. The method according to claim 2, wherein the current rotational speed of the asynchronous motor is determined as a function of a power consumption of the asynchronous motor.

13. The method according to claim 2, wherein adjusting said three-phase frequency comprises:
controlling the power consumption of the asynchronous motor, wherein the maximum rotational speed deviation corresponds to a maximum power consumption deviation.

14. The pump arrangement according to claim 7, wherein said control device is designed such that in the case of failure of said at least one working pump, said substitute pump is activated and is brought to the rotational speed of the failed working pump.
